(19) United States
(12) Patent Application Publication
(10) Pub. No.: US 2013/0208448 A1
(43) Pub. Date: Aug. 15, 2013

(54) Backlight Module

(71) Applicants: YaJun Yu, Shenzhen (CN); YuChun Hsiao, Shenzhen (CN)

(72) Inventors: YaJun Yu, Shenzhen (CN); YuChun Hsiao, Shenzhen (CN)

(73) Assignee: Shenzhen China Star Optoelectronics Technology Co., Ltd., Shenzhen City, Guangdong (CN)

(21) Appl. No.: 13/509,378

(22) PCT Filed: Mar. 16, 2012
(86) PCT No.: PCT/CN2012/072409

§ 371 Date: May 11, 2012

(30) Foreign Application Priority Data
Feb. 15, 2012 (CN) 201210033995.2

(51) Int. Cl. G09F 13/04

(52) U.S. Cl. 362/97.1

(57) ABSTRACT

The present invention provides a backlight module, which includes a backboard, a backlight source arranged inside the backboard, a diffusion board mounted on the backboard, and a reflection member arranged inside the backboard. The backlight source emits light that directly enters or is reflected by the reflection member to get incident to the diffusion board. The reflection member includes a bracket and a reflection unit mounted on the bracket. The bracket is made of paper material and has a concave curved surface. The reflection unit is mounted on the concave curved surface. The backlight module is configured to arrange the reflection unit on the paper-made bracket to form the reflection member that can replace the existing reflection plate. Since the paper material has a low cost and is easy to shape, the manufacture cost of the reflection member and thus the whole backlight module are reduced.

### BACKGROUND OF THE INVENTION

1. Field of the Invention

The present invention relates to the technical field of liquid crystal displaying, and in particular to a backlight module.

2. The Related Arts

Liquid crystal display (LCD) has a variety of advantages, such as compact device size, low power consumption, and being free of radiation, and is thus widely used. Most of the LCDs that are currently available in the market are backlighting LCDs, which comprise a liquid crystal panel and a backlight module. The working principle of the liquid crystal panel is that liquid crystal molecules are interposed between two parallel glass plates and a plurality of vertical and horizontal fine electrical wires is arranged between the two glass plates, whereby the liquid crystal molecules are controlled to change direction by application of electricity to refract light emitting from the backlight module for generating images. Since the liquid crystal panel itself does not emit light, light must be provided by the backlight module in order to generate images. Thus, the backlight module is one of the key components of an LCD. The backlight module can be classified as two types, namely side-edge backlight module and direct backlight module, according to the position where light gets incident. The direct backlight module arranges a light source, such as a cold cathode fluorescent lamp (CCFL) or a light-emitting diode (LED) at the back side of the liquid crystal panel to form a planar light source to directly provide lighting to the liquid crystal panel. The side-edge backlight module arranged an LED light bar at an edge of a backboard that is located rearward of one side of the liquid crystal panel. The LED light bar emits light that enters a light guide plate through a light incident face of the light guide plate and is projected out through a light exit face after being reflected and diffused to thereby form a planar light source to be provided to the liquid crystal panel.

As shown in FIG. 1, to reduce the number of LEDs used in a backlight source of a backlight module, the conventional direct backlight module comprises a backboard 200, an LED light bar 100 arranged at a central position of the backboard 200, and reflection plates 300 arranged at opposite sides of the LED light bar 100. The reflection plates 300 are formed as arc-curved reflection surface through vacuum forming in order to convert the light emitting from the LED light bar 100 into a planar light source to be guided to the whole liquid crystal display panel. This may moderately lower down the manufacture expenditure without affecting the luminance of the whole backlight module.

As shown in FIG. 2, to reduce the cost while maintaining homogenous lighting, the conventional side-edge backlight module comprises a backboard 200, LED light bars 100′ arranged at opposite sides of the backboard 200′, and a reflection plate 300′ arranged inside the backboard 200′. The reflection plate 300′ is formed as two successively-juxtaposed arc-curved reflection surfaces through vacuum forming. The two arc-curved reflection surfaces respectively correspond to and reflect lights emitting from the LED light bars 100′ at the two sides of the backboard 200′ so as to re-direct the lights toward the whole liquid crystal display panel to provide homogenous planar light source to the whole liquid crystal display panel.

However, in the above two solutions, the reflection plates are micro cellular polyethylene terephthalate (MCPET) boards made through vacuum forming. The micro cellular PET boards are foamed using PET as the base material, which shows excellent light reflectivity (more than 99% total reflection rate, diffusion reflection rate: 96%, mirror reflection rate: 3%). However, micro cellular PET boards are of high cost, and in addition, the vacuum forming process is also of high cost, both being adverse to cost control of the backlight module.

### SUMMARY OF THE INVENTION

An objective of the present invention is to provide a backlight module, which comprises a reflection member that is formed by arranging a reflection unit on a paper-made bracket to replace the existing MCPET reflection board adopted in the known techniques so as to make the structure simple and the cost low.

To achieve the objective, the present invention provides a backlight module, which comprises: a backboard, a backlight source arranged inside the backboard, a diffusion board mounted on the backboard, and a reflection member arranged inside the backboard. The backlight source emits light that directly enters or is reflected by the reflection member to get incident to the diffusion board. The reflection member comprises a bracket and a reflection unit mounted on the bracket. The bracket is made of paper material. The bracket has a concave curved surface. The reflection unit is mounted on the concave curved surface.

The reflection unit comprises a titania powder layer coated on the concave curved surface.

The concave curved surface of the bracket comprises a plurality of successively-juxtaposed concave arc surfaces.

The backboard comprises a bottom plate and side plates mounted to the bottom plate. The side plates and the bottom plate define a receiving space. The backlight source and the reflection member are received in the receiving space. The reflection member is mounted on the bottom plate. The backlight source is mounted to the side plates. The backlight source emits light that directly enters or is reflected by the reflection member to get incident to the diffusion board.

The concave curved surface of the bracket comprises a concave arc surface.

The backboard comprises a bottom plate and side plates mounted to the bottom plate. The side plates and the bottom plate define a receiving space. The backlight source and the reflection member are received in the receiving space. The reflection member is mounted on the bottom plate. The backlight source is arranged at a central position of the bottom plate and exactly located below the diffusion board. The bracket of the reflection member forms a channel corresponding to the backlight source. The backlight source is received in the channel.

The backlight source comprises an LED-based linear light source.

The bracket of the reflection member is formed by hot-pressing the paper material.

Also included is an optic film arranged on the diffusion board.

The reflection unit comprises a reflection plate attached to the bracket.

The efficacy of the present invention is that the present invention provides a backlight module, which arranges a reflection unit on a bracket that is made of paper material to form a reflection member for replacing the known MCPET plate made with existing techniques. Since the paper material has a low cost and is easy to shape, the manufacture cost of the reflection member can be reduced and the manufacture cost of the whole backlight module is thus reduced. The reflection unit can be a titania powder layer coated on the bracket or an existing non-vacuum-formed reflection plate attached to the bracket, so as to further reduce the manufacture cost of the reflection member while ensuring desired effect of reflection.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of embodiments of the present invention, with reference to the attached drawings. In the drawings:

FIG. 1 is a schematic view showing a conventional direct backlight module;

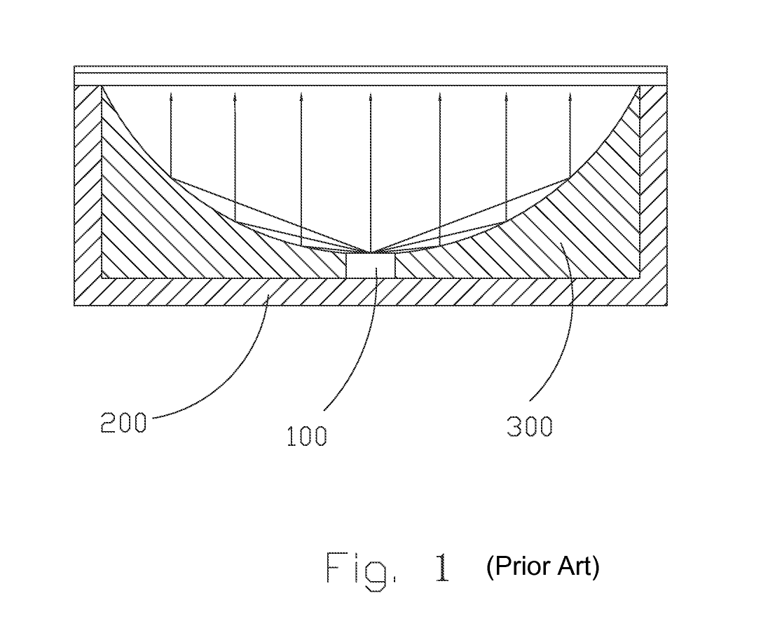

FIG. 2 is a schematic view showing a conventional side-edge backlight module;

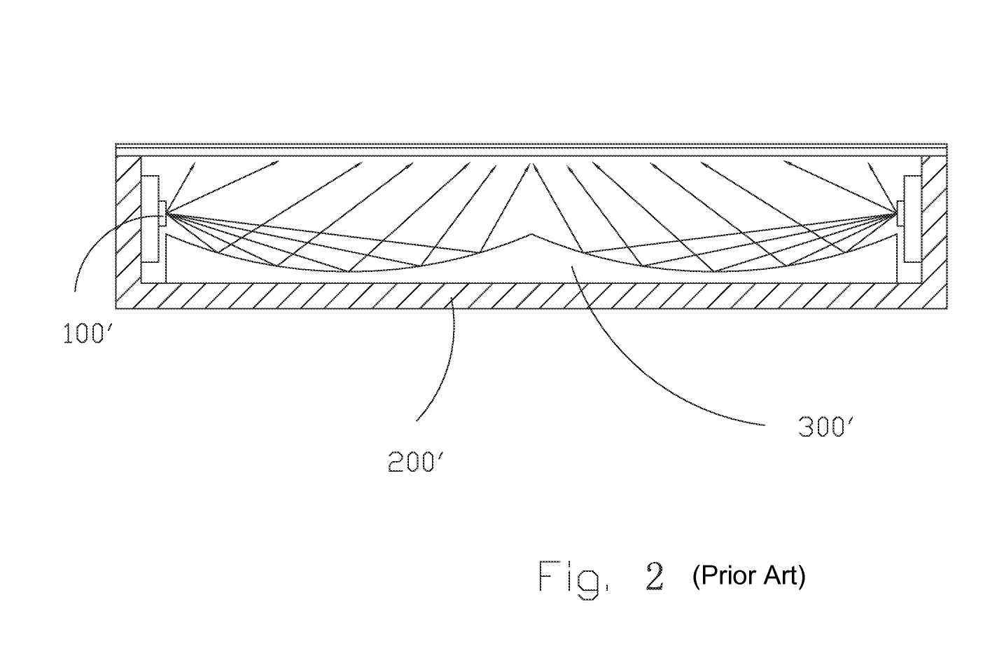

FIG. 3 is a schematic view showing a backlight module according to an embodiment of the present invention; and

FIG. 4 is a schematic view showing a backlight module according to another embodiment of the present invention.

### DETAILED DESCRIPTION OF THE PREFERRED EMBODIMENTS

To further expound the technical solution adopted in the present invention and the advantages thereof, a detailed description is given to preferred embodiments of the present invention and the attached drawings.

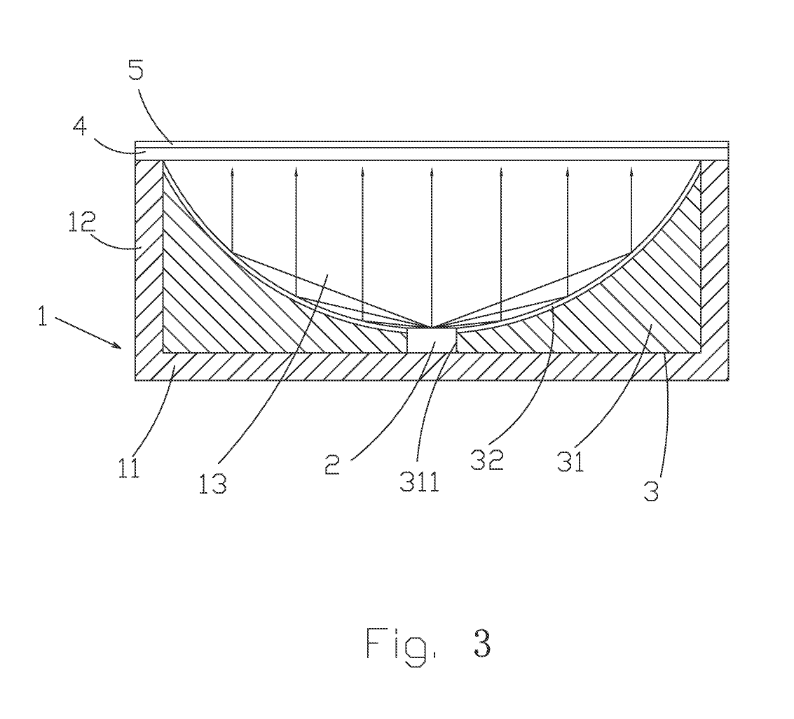

Referring to FIG. 3, which is a schematic view showing a backlight module according to an embodiment of the present invention, the backlight module comprises: a backboard 1, a backlight source 2 arranged inside the backboard 1, a reflection member 3 arranged inside the backboard 1, a diffusion board 4 mounted on the backboard 1 and located above the reflection member 3, and an optic film 5 arranged on the diffusion board 4. The backlight source 2 emits light that directly enters or is reflected by the reflection member 3 to get incident to the diffusion board 4, and then enters the optic film 5. The arrangement of the reflection member 3 makes the brightness of the diffusion board 4 homogenized and passing through the optic film 5 to form a brightness-homogenized planar light source for a liquid crystal display panel (not shown). The optic film 5 can be a brightness enhancement film or a polarization conversion film for conversion of polarization of light or a combination of both.

The backboard 1 comprises a bottom plate 11 and side plates 12 mounted to the bottom plate 11. The side plates 12 and the bottom plate 11 define a receiving space 13. The backlight source 2 and the reflection member 3 are received in the receiving space 13.

The reflection member 3 comprises a bracket 31 and a reflection unit 32 mounted on the bracket 31. The bracket 31 is formed by hot-pressing paper material. The bracket 31 has a concave curved surface and the reflection unit 32 is mounted on the concave curved surface of the bracket 31. The concave curved can be a concave arc surface and the reflection unit 32 is a titania powder layer coated on the concave arc surface or an existing non-vacuum-formed reflection plate. Since the present invention forms the bracket with paper material on which the titania powder layer is coated or a non-vacuum-formed reflection plate is attached to form the reflection member, compared to the known techniques that adopt vacuum forming process to form an MCPET board, the manufacture cost is greatly reduced.

The backlight source 2 comprises an LED-based linear light source, which is disposed at a central position of the bottom plate 11 of the backboard 1 and is exactly located below the diffusion board 4. The bracket 31 of the reflection member 3 forms a channel 311 corresponding to the backlight source 2 and the backlight source 2 is received in the channel 311 to form a direct backlight module. Light emitting from the backlight source 2 may directly enter or is reflected by the reflection member 3 to get incident to the diffusion board 4 so as to make the brightness of the diffusion board 4 homogenous and providing a planar light source with homogenized brightness to a liquid crystal display panel.

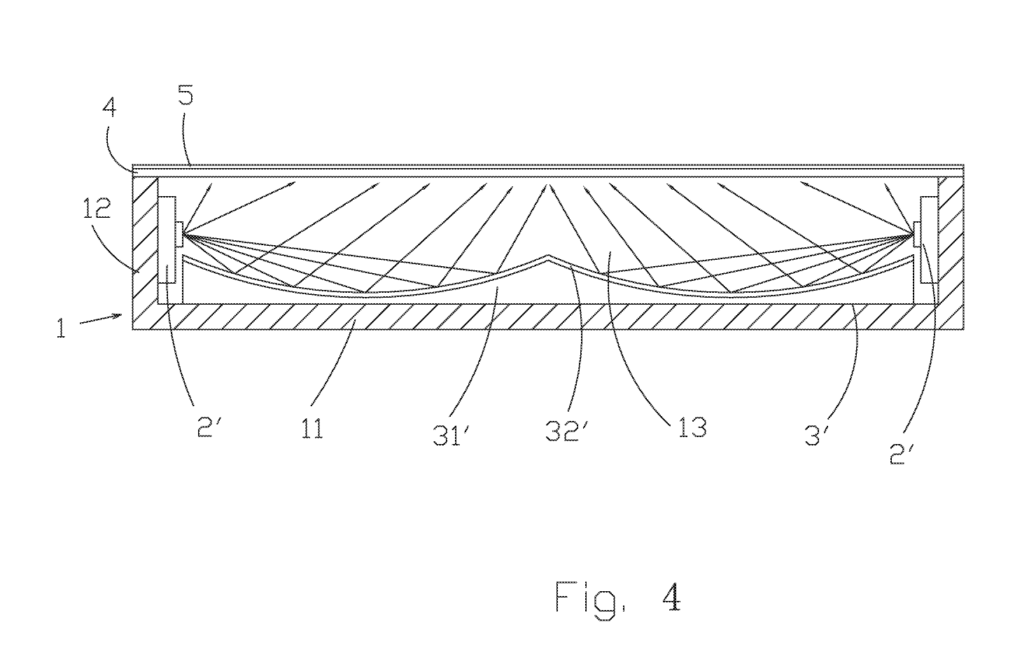

Referring to FIG. 4, which is a schematic view showing a backlight module according to another embodiment of the present invention, the backlight module comprises: a backboard 1, backlight source 2′ arranged inside the backboard 1, a reflection member 3′ arranged inside the backboard 1, a diffusion board 4 mounted on the backboard 1 and located above the reflection member 3′, and an optic film 5 arranged on the diffusion board 4. The backlight sources 2′ emit light that directly enters or is reflected by the reflection member 3′ to get incident to the diffusion board 4, and then enters the optic film 5. The arrangement of the reflection member 3′ makes the brightness of the diffusion board 4 homogenized and passing through the optic film 5 to form a brightness-homogenized planar light source for a liquid crystal display panel.

The backboard 1 comprises a bottom plate 11 and side plates 12 mounted to the bottom plate 11. The side plates 12 and the bottom plate 11 define a receiving space 13. The backlight sources 2′ and the reflection member 3′ are received in the receiving space 13.

The reflection member 3′ comprises a bracket 31′ and a reflection unit 32′ mounted on the bracket 31′. The bracket 31′ is formed by hot-pressing paper material. The bracket 31′ has a concave curved surface and the concave curved surface is composed of a plurality of successively-juxtaposed concave arc surfaces. The reflection unit 32′ is a titania powder layer coated on the concave curved surface or an existing non-vacuum-formed reflection plate. Since the present invention forms the bracket with paper material on which the titania powder layer is coated or a non-vacuum-formed reflection plate is attached to form the reflection member, compared to the known techniques that adopt vacuum forming process to form an MCPET board, the manufacture cost is greatly reduced.

Preferably, the concave curved surface of the instant embodiment comprises two successively-juxtaposed concave arc surfaces and the two concave arc surface forms a connection therebetween that is lower in altitude than free ends of the two concave arc surface so that desired effect of reflection can be realized but no blocking of light may occur, intensity of lighting can be ensured to thereby maintain the luminance of the overall backlight module. The backlight sources 2′ comprise LED-based linear light sources, which are mounted to the two opposite side plates 12 of the backboard 1 to respectively correspond to the two concave arc surfaces to thereby form a side-edge backlight module. Light emitting from the backlight sources 2′ may directly enters or is reflected by the reflection member 3′ to get incident to the diffusion board 4 so as to make the brightness of the diffusion board 4 homogenous and providing a planar light source with homogenized brightness to a liquid crystal display panel.

In summary, the present invention provides a backlight module, which arranges a reflection unit on a bracket that is made of paper material to form a reflection member for replacing the known MCPET plate made with existing techniques. Since the paper material has a low cost and is easy to shape, the manufacture cost of the reflection member can be reduced and the manufacture cost of the whole backlight module is thus reduced. The reflection unit can be a titania powder layer coated on the bracket or an existing non-vacuum-formed reflection plate attached to the bracket, so as to further reduce the manufacture cost of the reflection member while ensuring desired effect of reflection.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising: a backboard, a backlight source arranged inside the backboard, a diffusion board mounted on the backboard, and a reflection member arranged inside the backboard, the backlight source emitting light that directly enters or is reflected by the reflection member to get incident to the diffusion board, the reflection member comprising a bracket and a reflection unit mounted on the bracket, the bracket being made of paper material, the bracket having a concave curved surface, the reflection unit being mounted on the concave curved surface.

2. The backlight module as claimed in claim 1, wherein the reflection unit comprises a titania powder layer coated on the concave curved surface.

3. The backlight module as claimed in claim 2, wherein the bracket concave curved surface comprises a plurality of successively-juxtaposed concave arc surfaces.

4. The backlight module as claimed in claim 3, wherein the backboard comprise a bottom plate and side plates mounted to the bottom plate, the side plates and the bottom plate defining a receiving space, the backlight source and the reflection member being received in the receiving space, the reflection member being mounted on the bottom plate, the backlight source being mounted to the side plates, the backlight source emitting light that directly enters or is reflected by the reflection member to get incident to the diffusion board.

5. The backlight module as claimed in claim 2, wherein the concave curved surface of the bracket comprises a concave arc surface.

6. The backlight module as claimed in claim 5, wherein the backboard comprise a bottom plate and side plates mounted to the bottom plate, the side plates and the bottom plate defining a receiving space, the backlight source and the reflection member being received in the receiving space, the reflection member being mounted on the bottom plate, the backlight source being arranged at a central position of the bottom plate and exactly located below the diffusion board, the bracket of the reflection member forming a channel corresponding to the backlight source, the backlight source being received in the channel.

7. The backlight module as claimed in claim 1, wherein the backlight source comprises an LED-based linear light source.

8. The backlight module as claimed in claim 1, wherein the bracket of the reflection member is formed by hot-pressing the paper material.

9. The backlight module as claimed in claim 1 further comprising an optic film arranged on the diffusion board.

10. The backlight module as claimed in claim 1, wherein the reflection unit comprises a reflection plate attached to the bracket.
